(19) United States
(12) Patent Application Publication
(10) Pub. No.: US 2016/0163224 A1
(43) Pub. Date: Jun. 9, 2016

(54) Dynamic Video Coaching System

(71) Applicant: Pear Sports LLC, Solana, CA (US)

(72) Inventors: Kari Kristian Rauhala, Solana Beach, CA (US); Eric Franchomme, San Diego, CA (US); Robert G. Allison, Corona Del Mar, CA (US); Simon Sollberger, San Francisco, CA (US)

(21) Appl. No.: 14/960,248

(22) Filed: Dec. 4, 2015

Related U.S. Application Data
(60) Provisional application No. 62/088,485, filed on Dec. 5, 2014.

(51) Int. Cl. G09B 19/00; G09B 5/06; H04L 29/06

(52) U.S. Cl. CPC G09B 19/003; H04L 65/60; G09B 5/06

(57) ABSTRACT

A dynamic video coaching system is described that can provide customized and user-specific workout videos. For example, the dynamic video coaching system can provide a user with a series of video segments and audio files that are based on feedback associated with the user. The video segment files and audio files can assist the user in achieving a fitness goal that is either defined by the user or defined by a specific workout routine selected by the user.

### CROSS-REFERENCE TO RELATED APPLICATIONS

The current application claims priority under 35 U.S.C. §119(e) to application No. 62/088,485 filed Dec. 5, 2014.

### TECHNICAL FIELD

The subject matter described herein relates to a computer implemented dynamic video coaching system that provides video content that dynamically changes based on account feedback data associated with a user and/or his or her environment while the user is undergoing physical activity.

### BACKGROUND

Traditional workout videos can provide a user with set physical exercise routines that have been pre-recorded and are not dynamically customizable based on a user's feedback. At best, such traditional workout videos provide one or more levels of physical exercise routines that the user can select to follow along to. Over time, the user can get accustomed to and loose interest in the traditional workout videos due to either the exercise routines no longer improving their physical fitness or getting tired of repeating the same exercises defined in the routines. In addition, traditional workout videos do not provide the user with feedback so the user is not able to know whether the user is performing the exercises correctly and beneficially.

### DESCRIPTION OF DRAWINGS

FIG. 1 is a diagram illustrating a dynamic video coaching system including a cloud based server and a video streaming application loaded onto a user device;

FIG. 2 illustrates a video segment selection tree that provides options for selecting video segments and/or audio files to play for a user;

FIG. 3 illustrates a first screen shot showing more than one video segment being played simultaneously within a display, such as a display associated with the user device;

FIG. 4 illustrates a second screen shot showing workout information overlaying a video segment being played on the display;

FIG. 5 illustrates a third screen shot showing captured video of a user overlaying a video segment being played on the display; and

FIG. 6 illustrates a data flow diagram showing at least a part of a method associated with the dynamic video coaching system described herein.

When practical, similar reference numbers denote similar structures, features, or elements.

### DETAILED DESCRIPTION

The current subject matter is directed to a dynamic video coaching system that can provide customized and user-specific workout videos. For example, the dynamic video coaching system can provide a user with a series of video segments that are based on the user's needs, such as based on feedback associated with the user. The feedback associated with the user can include physiological data (e.g., heart rate, temperature, etc.), user-provided feedback (e.g., instructions to slow down pace), and/or environmental data (e.g., surrounding temperature, humidity level, time of day, etc.). The video segments provided to the user that are based on the feedback received by the system can include one or more parts of a workout routine that can assist the user in achieving a fitness goal.

In some implementations of the dynamic video coaching system, a user can define a fitness goal or select a workout routine that has a fitness goal associated with the workout routine. The dynamic video coaching system can then start playing a first video segment for the user based on the user's fitness goal and/or selected workout routine. In addition, based on one or more feedback data collected by the dynamic video coaching system, such as while the user follows along to the first video segment, the dynamic video coaching system can select a second video segment to play for the user in order to assist the user with achieving the fitness goal.

The dynamic video coaching system can include a video streaming application that can be downloaded onto a user device (e.g., mobile phone, tablet computer, etc.) and can interact with the user, such as collect and analyze sensed and user-entered feedback data as well as play video segments. The dynamic video coaching system can also include a cloud based server that can store video segment files and provide (i.e., download) the video segment files to the video streaming application. The dynamic video coaching system can further include various other components, as will be discussed in greater detail below, such as sensors, cameras, and smart televisions that can communicate with both the cloud based server and the video streaming application.

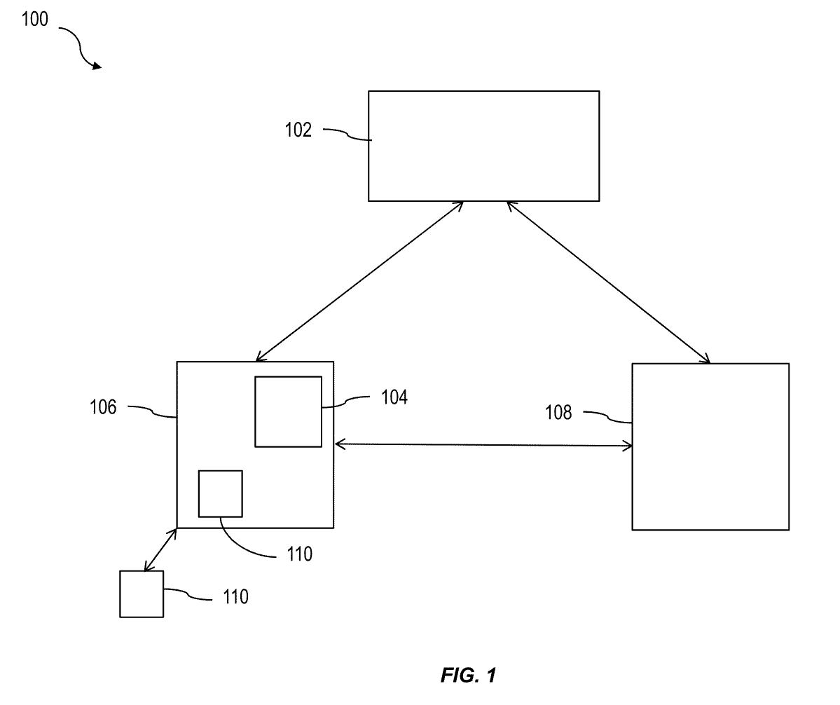

FIG. 1 illustrates a dynamic video coaching system 100 that includes a cloud based server 102 and a video streaming application 104 loaded onto a user device 106, such as a m bile device (e.g., smart phone, tablet computer, etc.). The cloud based server 102 and the video streaming application 104 can communicate with each other, such as via the internet.

The video streaming application 104 can provide a user interface that allows the user to interact with the dynamic video coaching system 100, such as select a workout routine, define fitness goals, and provide feedback. Video segments can be played through the video streaming application 104 and/or the video segments can be streamed to another device, such as a smart television 108. The video segments can be played by the dynamic video coaching system 100 in a sequence that is based on feedback from the user. In addition, the video segments can be played one at a time or two or more at a time, such as one viewing screen playing two video segments (e.g., a picture within a picture) or a video segment overlaying another video segment.

The cloud based server 102 can store the video segment files and provide download) the video segment files to the video streaming application 104 and/or any viewing platform (e.g., smart television 108). Each video segment file can include metadata that allows the cloud based server 102 and/or the video streaming application 104 to select appropriate video segments for downloading and playing. In addition, the cloud based server 102 can store audio files that can be provided to the video streaming application 104 and/or viewing platform, such as for playing audio instructions or music for the user.

In addition, some implementations of the dynamic video coaching system 100 can include one or more sensors 110 that can sense feedback data associated with the user, such as physiological data (e.g., heart rate, calories burned, etc.) and/or environmental data (e.g., temperature), which can be used by the dynamic video coaching system 100 for dynamically customizing the user's workout video. Sensed data can be retrieved by the dynamic coaching system 100 either directly or wirelessly (e.g., Bluetooth, etc.) and can be analyzed by, for example, the video streaming application 104. In addition, any one of the sensors 110 can be a camera, such as for capturing images of the user, and/or a user-input feature that allows the user to provide various feedback to the dynamic video coaching system 100. For example, the user-input feature can include a button or visual sensor that, when activated by the user, instructs the dynamic video coaching system 100 to start or stop the workout. Other sensors 110 can include any sensors that are built into the user device 106, such as movement sensors in a smartphone. The user device 106, such as the smartphone, can also query the cloud based server 102 for data, such as stored data associated with the user (e.g., data associated with a user profile). In addition, one or more sensors 110 can be placed adjacent or near the user in order to sense positioning and/or movement of the user, such as cameras, pressure sensors, contact sensors, etc., as be described in greater detail below. Furthermore, any sensor 110 can be worn by the user (i.e., primary user) and/or a secondary user, such as a competitor, for allowing feedback data associated with the primary user and/or secondary user to assist with dynamically customizing the primary user's workout routine.

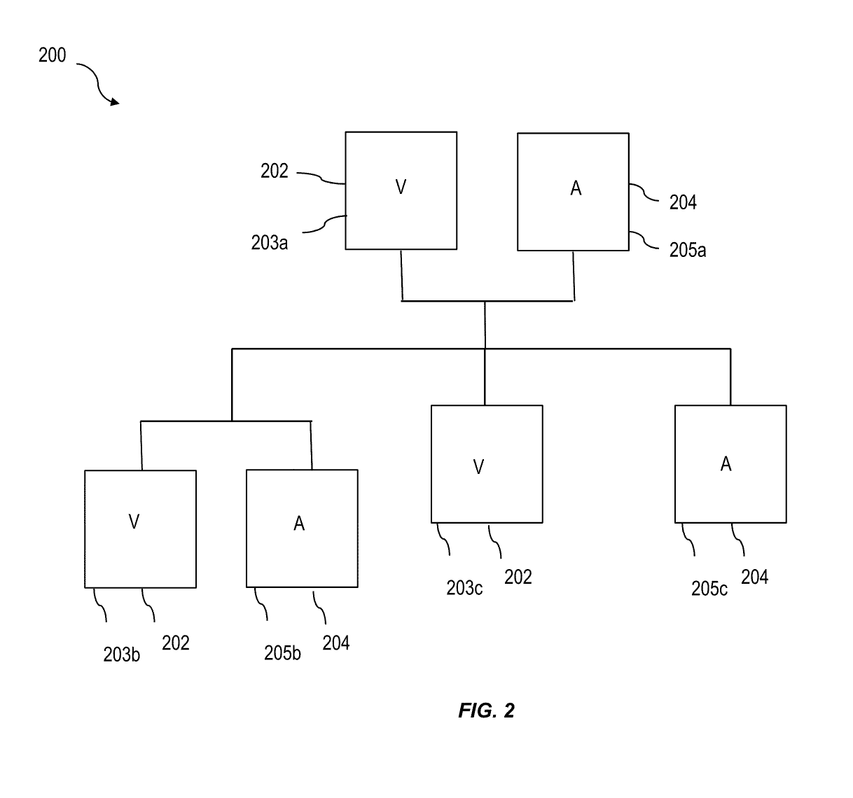

FIG. 2 illustrates an example video segment selection tree 200 that provides options for selecting video segments 202 and/or audio files 204 to play for a user. Each video segment file 202 and audio file 204 can include metadata that can assist the dynamic video coaching system 100 with selecting video segment files 202 and audio files 204 to play to the user in order to assist the user with achieving a fitness goal.

For example, the user can define a fitness goal to burn a specific number of calories within a specified duration (e.g., 30 minutes). The dynamic video coaching system 100, such as the video steaming application 104, can select a series of video segments 202 to play to the user based on the metadata associated with the video segments 202 in order to assist the user in achieving the fitness goal. Additionally, the video streaming application 104 can base video segment 202 selections on time and physiological feedback data (e.g., calories burned) received from the user.

Alternatively or in addition, the user can define a fitness goal to complete a specific workout routine (e.g., P90X, kettlebell workout, etc.) and the dynamic video coaching system 100 can splice the specific workout routine into video segments 202, where each video segment 202 can include metadata that can include one or more fitness goals. The dynamic video coaching system 100 can play the video segments 202 in an order that is appropriate for the user based on the user's feedback and metadata associated with each video segment 202. In addition, the dynamic video coaching system 100 can skip or delete video segments 202 of a specific workout routine based on analyzed user feedback, such as skip a higher intensity video segment 202 if analysis of the user feedback indicates that a lower intensity video segment 202 is more appropriate fir the user. The dynamic video coaching system 100 can compare feedback data from the user against the metadata associated with either the entire specific workout routine or a video segment 202 in order to determine appropriate video segments 202 to play and in which order to play them in. This can assist the user with completing the specific workout routine and/or fitness goals associated with the specific workout routine.

Metadata associated with either a specific workout routine or video segment 202 can, for example, define target heart rates, heart rate zones, step counts, movement counts, and/or duration of movements. For example, a video segment 202 can include metadata defining a target step count the user is suggested to achieve. As such, while the video segment 202 is playing for the user the video streaming application 104 can receive sensor data indicating a number of steps the user has taken. The video streaming application 104 can compare the sensed number of steps against the metadata defining the target step count for the video segment 202. Once the number of steps the user has taken matches the target number of steps defined in the metadata, the video streaming application 104 can arrange for the next appropriate audio file 204 and/or video segment 202 to play for the user. The video streaming application can either select an appropriate audio 204 file and/or video segment 202 from a local database, such as on the user device 106, or query the cloud based server 102 for an appropriate audio file and/or video segment 202. An appropriate audio file 204 and/or video segment 202 can be determined based on, for example, the metadata associated with the specific workout routine and/or user-defined workout goal. As such, the video streaming application 104 can select a variety of audio files 204 and video segments 202 for dynamically assisting the user with achieving a fitness goal.

Furthermore, audio files and/or video segments 202 can be selected by the video streaming application 104 for simultaneous play along with a currently playing audio file 204 and/or video segment 202. For example, the video streaming application 104 can select an audio file 204 to play that encourages the user to increase the user's pace if the video streaming application 104 determines that the user is not on track to reach a fitness goal, such as complete a number of steps within an amount of time.

As shown in FIG. 2, the dynamic video coaching system 100 can play, for example, a first video segment 203a and a first audio file 205a based on a selection by the user, such as a selection of a specific workout routine. The first video segment 203a and/or the first audio file 205a can include metadata that define one or more fitness goals, such as a heart rate the user is expected to achieve while either the first video segment 203a or first audio file 205a plays for the user. The video streaming application 104 can collect user feedback data, such as the user's heart rate, and compare it to the metadata order to determine an appropriate subsequent video segment 202 and/or audio file 204. For example, if the user's heart rate reaches a level that is higher than a heart rate fitness goal associated with the first video segment 203a, the video streaming application 104 can select to subsequently play a second video segment 203b and/or second audio segment 205b that can assist in lowering the user's heart rate. However, if the user's heart rate reaches a level that is tower than a heart rate fitness goal associated with the first video segment 203a, the video streaming application 104 can instead select to subsequently play a third video segment 203c and/or third audio segment 205c that can assist in lowering the user's heart rate.

Video segments not associated with the specific workout routine can be played for the user based on the user's needs, such as video segments that can assist with increasing or decreasing the user's heart rate or correcting a user's form. In addition, any number of video segments 202 and/or audio files 204 can be selected for subsequent playing. As such, video segment files 202 and audio files 204 can be selected for individual play and/or played with another file (i.e., video segment file 202, audio file 204).

In some implementations of the dynamic video coaching system 100, the video streaming application 104 can play a static workout video, such as a pre-recorded workout video that is not customized based on user feedback. In addition to the static workout video, the video streaming application 104 can also play a picture-in-picture or over-lay of a second video or second video segment that is customized based on user feedback. In order to synchronize the playing of the second video segment and the static workout video, the video streaming application 104 can match time stamps associated with the second video segment and the static workout video. The synchronized playing of the second video segment and the static workout video can be merged on a viewing platform, such as a display of the user device 106 or on the smart television 108.

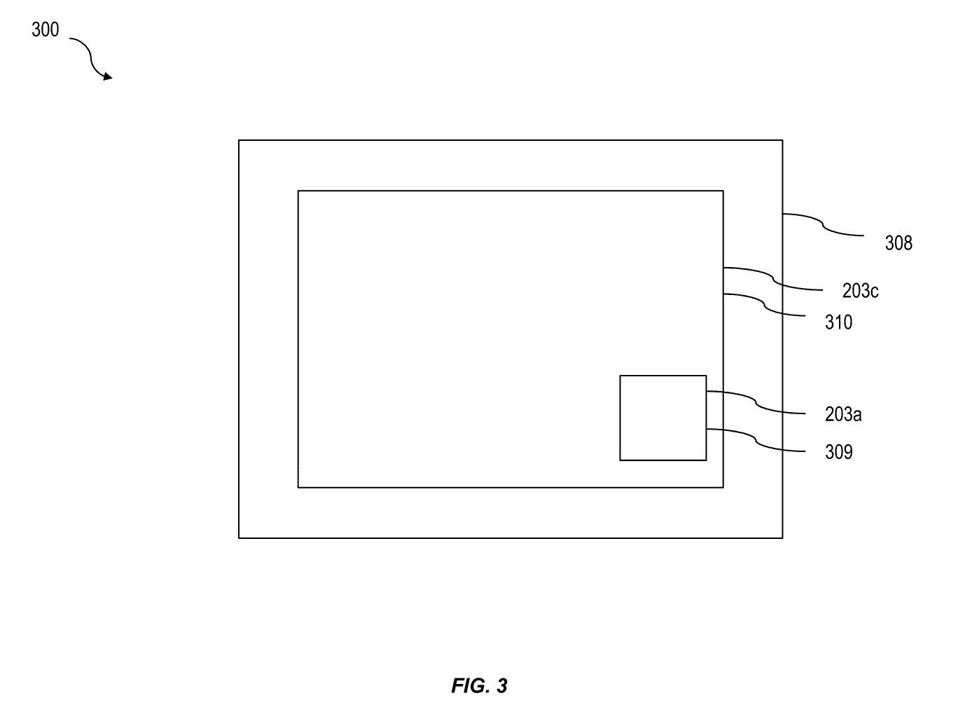

FIG. 3 illustrates a first screen shot 300 showing more than one video segment being played simultaneously within a display 308, such as a display associated with the user device 106. For example, a first part 309 of the display 308 can play the first video segment 203a and a second part 310 of the display 308 can play the third video segment 203c. The first video segment 203a and the third video segment 203c can begin and/or end at the same or different times, and metadata associated with either video segment can be used by the video streaming application 104 for analyzing the user's performance and determining subsequent video segments 202 and/or audio files 204 to play. Although the first part 309 of the display is shown a different size and positioned within the second part 310 of the display, the display 308 can have any number of parts (e.g., first part 309, second part 310, etc.) that are sized and positioned relative to each other in any number of a variety of ways.

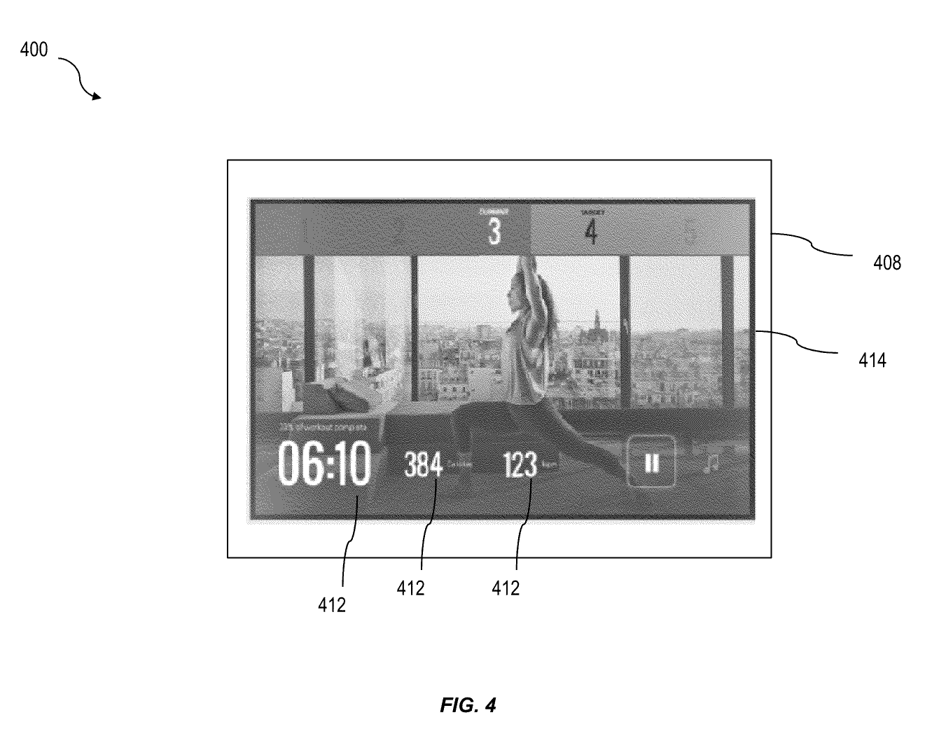

FIG. 4 illustrates a second screen shot 400 showing workout information 412 overlaying a video segment 414 being played on the display 408. The workout information 412 can include a variety of information associated with the user and/or the workout routine elected by the user, such as number of calories burned, heart rate, time, music selection, etc. The music selection can be customized by either the user or the dynamic video coaching system, including stopping and starting the music, as well as selecting which songs to play at what time during the workout.

For example, a user can select one or more songs or playlists to play during the workout. The dynamic video coaching system 100 can play the songs or playlist during the workout, including phasing out the music when appropriate in order to allow audio associated with a video file 202 and/or audio file 204 to play, such as when workout instruction to be provided to the user. This can allow a user to enjoy a variety of music while performing the same or similar workout routine and still receiving instructions associated with the workout routine.

As discussed above, the dynamic video coaching system 100 can receive a variety of feedback from the user, which can include feedback from a variety of feedback sources. For example, feedback received from the user can include physiological data (e.g., heart rate, temperature, etc.), user-provided feedback (e.g., instructions to slow down pace, start workout, etc.), and/or environmental data (e.g., surrounding temperature). In addition, the feedback sources can include one or more of a variety of sensors, cameras, input features, etc.

For example, the user can wear any number of sensors, such as a heart rate monitor, that sends sensed data (e.g., wirelessly, such as via Bluetooth) to the video streaming application 104 for analysis. In addition, one or more sensors can be placed adjacent or near the user in order to sense positioning and/or movement of the user, such as sensors associated with a yoga mat that detects the user's positioning and/or movement (e.g., location and orientation of the user's feet and/or hands, number of steps, etc.) relative to the yoga mat. Additionally, one or more cameras can be placed adjacent or near the user in order to record the user's movements, including the user's alignment, form and positioning. Sensors can also include input features, such as, for example, an activation button or video streaming application selection that allows the user to either modify a fitness goal (e.g., lower an intensity level) or control the starting and stopping of a workout. As an example, the user can wear an activity monitory (e.g., Fitbit, etc.) that can wirelessly provide sensed data (e.g., step counts) to the video streaming application, which can analyze the sensed data in order to determine subsequent audio file 204 and video segments 202 to play for the user.

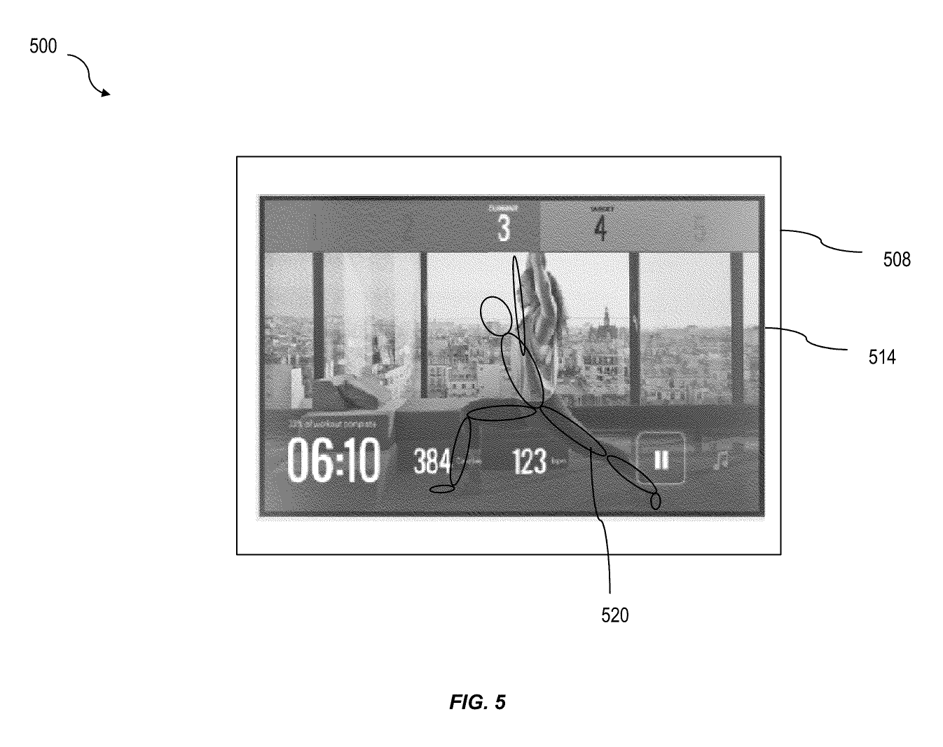

FIG. 5 illustrates a third screen shot 500 showing additional examples of feedback data overlaying a video segment 514 being played on a display 508. In particular, captured video 520 of the user by a camera that is in communication with the dynamic video coaching system 100 can be overlaid over the video segment 514 being played on the display 508. This can allow a user to analyze, for example, the user's form, positioning and/or movements compared to what is being shown in the display 508, which can allow the user to more easily correct his or her form, positioning and/or movements. In some implementations, the user can pause the video segment 514 and allow the camera to continue to record the user and display the captured video 520 of the user over the paused video segment 514. This can assist in allowing a user to correct, for example, his or her form and alignment compared with what is being shown in the viewing screen before continuing the workout.

In some implementations of the dynamic video coaching system 100, one or more user devices can be associated with video cameras that can be used to detect and/or measure form, positioning and movements of the user. The user devices can collaborate information collected by the video cameras in order to provide three-dimensional data associated with the user's form, positioning and/or movements. This can provide a user with three-dimensional information related to the user's training, which can assist with improving the user's performance.

In some implementations of the dynamic video coaching system 100, the cloud based server 102 can receive information about the user to create a user profile, such as information related to the user's past workouts, contextual data collected from the user during previous workouts, user's preferences, gender, workout history, weight, height, current fitness level, activity class, etc. Alternatively or in addition, the user profile can be stored locally on the user's device, which can be accessed by the video streaming application 104. Based on information contained within the user profile, the dynamic video coaching system 100 can either recommend or play workouts for the user, such as workouts that are more challenging or improve a particular area of fitness (e.g., cardio) for the user.

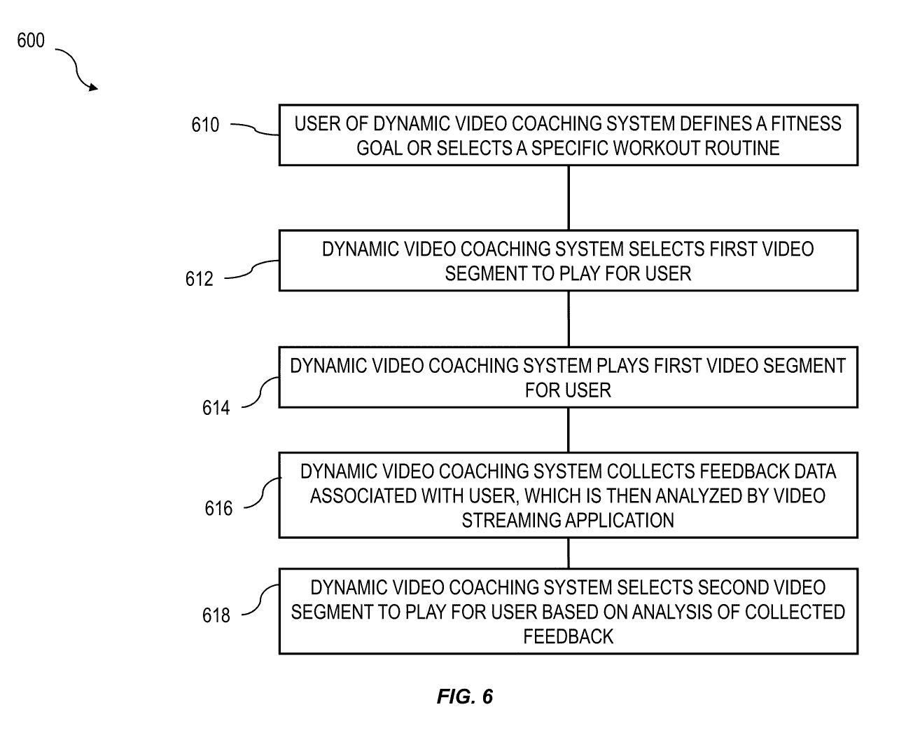

FIG. 6 illustrates a data flow diagram 600 showing at least a part of a method associated with the dynamic video coaching system 100 described herein. For example, at 610, a user of the dynamic video coaching system can define a fitness goal or select a specific workout routine. At 612, the dynamic video coaching system can select a first video segment to play for a user that is based on the fitness goal or selected workout routine. The first video segment can include first metadata that is used for selecting the first video segment and analyzing collected user feedback. At 614, the dynamic video coaching system 100 plays the first video segment for the user, such as on the display associated with the user device. At 616, the dynamic video coaching system collects feedback data associated with the user, which is then analyzed by the video streaming application 104. Analyzing of the feedback data can include comparing the feedback data with the first metadata associated with the first video segment. Based on the analysis, at 618, the dynamic video coaching system can select a second video segment to play for the user in order to assist the user with achieving the fitness goal.

One or more aspects or features of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device (e.g., mouse touch screen, etc.), and at least one output device.

These computer programs, which can also be referred to as programs, software, software applications, applications, components, or code, include machine instructions for a programmable processor, and can be implemented in a high-level procedural language, an object-oriented programming language, a functional programming language, a logical program min language, and/or in assembly/machine language. As used herein, the term “machine-readable medium” (sometimes referred to as a computer program product) refers to physically embodied apparatus and/or device, such as for example magnetic discs, optical disks, memory, and Programmable Logic Devices (PLDs), used to provide machine instructions and/or data to a programmable data processor, including a machine-readable medium that receives machine instructions as a machine-readable signal. The term “machine-readable signal” refers to any signal used to provide machine instructions and/or data to a programmable data processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flow(s) depicted in the accompanying figures and/or described herein do not necessarily require the particular order shown, or sequential order, to achieve desirable results. Other implementations may be within the scope of the following claims.

What is claimed is:

1. A method comprising:
receiving from a user of a dynamic video coaching system input representing a definition of a fitness goal or a selection of a workout routine, the dynamic video coaching system including a video streaming application and one or more sensors;
selecting, by the dynamic video coaching system, a first video segment to play for the user, the first video including first metadata and the selection being based on the fitness goal or the selection of the workout routine;
playing, by the video streaming application of the dynamic video coaching system, the first video segment on a display;
collecting, by the one or more sensors, feedback data associated with the user;
analyzing, by the dynamic video coaching system, the collected feedback data, the analyzing including comparing the collected feedback data with the first metadata; and
selecting, by the dynamic video coaching system based on the analyzing, a second video segment to play for the user.

2. A method in accordance with claim 1, further comprising splicing, by the video streaming application, the second video segment onto the first video segment for playing on the display.

3. A method in accordance with claim 1, further comprising:
substituting, by the video streaming application, the second video segment for the first video segment; and
playing, by the video streaming application, the second video segment on the display.

4. A method in accordance with claim 1, wherein one of the at least one of the one or more sensors is a heartrate monitor to monitor the heartrate of the user.

5. A method in accordance with claim 1, wherein the display comprises a portion of the dynamic video coaching system.

6. A dynamic video coaching system comprising:
a user device having an input for receiving input from a user, the input representing a definition of a fitness goal or a selection of a workout routine;
a video streaming application on the user device that selects, based on the input from the user, a first video segment to play for the user, the first video including first metadata, and the selection being further based on the fitness goal or the selection of the workout routine, the video streaming application further playing the first video segment on a display associated with the user device;
one or more sensors associated with the user device, the one or more sensors to collect feedback data associated with the user;
a feedback analyzer associated with the user device, the feedback analyzer to analyze the collected feedback data, the analyzing including comparing the collected feedback data with the first metadata, and to select a second video segment to play on the display for the user.

7. A dynamic video coaching system in accordance with claim 6, wherein the feedback analyzer is an application running on the user device.

8. A dynamic video coaching system in accordance with claim 6, wherein the feedback analyzer is an application running on a cloud-based server connected with the user device via a communications network.

9. A dynamic video coaching system in accordance with claim 6, wherein the video streaming application is further configured, in response to the feedback analyzer, to splice the second video segment onto the first video segment for playing on the display.

10. A dynamic video coaching system in accordance with claim 6, wherein the video streaming application is further configured, in response to the feedback analyzer, to substitute the second video segment for the first video segment, and to play the second video segment on the display.

11. A dynamic video coaching system in accordance with claim 6, wherein one of the at least one of the one or more sensors is a heartrate monitor to monitor the heartrate of the user.

12. A dynamic video coaching system in accordance with claim 6, wherein the display comprises a portion of the dynamic video coaching system.
